(19) United States
(12) Patent Application Publication
(10) Pub. No.: US 2018/0066537 A1
(43) Pub. Date: Mar. 8, 2018

(54) GAS TURBINE ENGINE

(71) Applicant: ROLLS-ROYCE plc, London (GB)

(72) Inventors: Steven A RADOMSKI, Nottingham (GB); Matthew D CURREN, Derby (GB)

(73) Assignee: ROLLS-ROYCE plc, London (GB)

(21) Appl. No.: 15/667,115

(22) Filed: Aug. 2, 2017

(30) Foreign Application Priority Data
Sep. 2, 2016 (GB) 1614889.2

(51) Int. Cl. F01D 25/10; F01D 9/04; F01D 25/00; F01D 25/02

(52) U.S. Cl. CPC F01D 25/10; F02C 3/04; F01D 25/005; F01D 25/02; F05D 2220/32; F05D 2240/121; F05D 2260/22141; F05D 2300/611; F05D 2300/605; F05D 2260/98; F05D 2260/40311; F05D 2300/43; F05D 2300/20; F05D 2300/121; F01D 9/041

(57) ABSTRACT

A vane for a gas turbine engine has a pressure surface and a suction surface. The vane comprises an arrangement of internal channels and a plurality of conducting members extends from the channels towards the suction surface and/or the pressure surface.

### TECHNICAL FIELD

The present disclosure concerns a vane, a gas turbine engine and/or a component having a heating arrangement.

### BACKGROUND

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven off an additional lower pressure turbine in the engine core.

Engine section stator (ESS) vanes are provided at the inlet to the engine core. These vanes guide air flow entering the core. The vanes may be structural i.e. be provided to support load between an inner and an outer casing member, or non-structural. It may be desirable for ESS vanes, particularly non-structural ESS vanes, to be as thin as possible to reduce noise and aerodynamic losses.

ESS vanes can experience ice build-up and this can be a particular problem for thin ESS vanes. In particular, if the gas turbine engine has a geared fan, the fan can rotate at a slower speed than fans that aren't geared, which can further increase ice build-up on the ESS vanes. Ice build-up is a problem because it can shed into the core of the engine and potentially lead to damage of engine components.

### SUMMARY

According to an aspect there is provided a vane for a gas turbine engine. The vane has a pressure surface and a suction surface. The vane comprises an arrangement of internal channels. A plurality of conducting members extends from the channels towards the suction surface and/or the pressure surface.

The internal channels are configured for containing a fluid.

The channels may define an oscillating heat pipe. In such examples, in use, the fluid is a bi-phase fluid. For example, the fluid may be considered to have liquid slugs and vapour plugs.

The conducting members may be considered to penetrate the channels.

The channels may be arranged to define a path along which heat transfer medium in the channels oscillate (e.g. define an oscillating heat pipe). The channels may define a path that is principally in a spanwise direction. The channels may define a path that extends in both a spanwise and a chordwise direction.

The channels may be capillary channels.

The vane may comprise a core that defines an aerofoil profile. The channels may be formed in the core.

The core may be formed of two members. One member of the core may define the suction surface. One member of the core may define the pressure surface. The channels may be defined by grooves in one or both of the two members.

The core may comprise an insulating material. For example, the core may comprise a plastic core, e.g. the core may be a plastic injection moulded core.

The core may comprise a ceramic material.

Each conducting member may extend from the channel towards the suction surface and towards the pressure surface.

The conducting members may be elongate members having a principal axis in a direction extending between the suction surface and the pressure surface. For example, the conducting members may be considered to be pins.

The conducting members may comprise fins that project into the channels.

The conducting members may be waisted so as to taper outwardly away from the channel. For example taper outwardly towards the pressure surface and/or the suction surface. The conducting members may be orthogonal to the channels.

The conducting members may be metallic members, for example aluminium or aluminium alloy pins.

One spanwise end of the vane may be made from a metallic material. For example, a plastic core may be provided on a metallic base.

The pressure surface and/or the suction surface and/or a transition region there between may be coated in a heat conducting material, e.g. a metallic material. For example, the metallic coating may be a nanocrystalline metallic coating.

The thickness of the coating may be varied across the pressure surface, suction surface and/or transition region. For example, the thickness of the coating may be varied so as to control heat conduction. The coating may be thicker in a region where increased heat conduction is desired.

The metallic coating may be thicker at a leading edge of the vane than at a trailing edge of the vane.

The channels and conducting members may the selectively positioned in regions where increased heat transfer is desired.

The channels and the conducting members may be arranged towards the leading edge of the vane. For example, a region proximal to the trailing edge may be free from channels and conducting members.

According to an aspect there is provided a vane comprising a core body defining an aerofoil profile, the core body comprising a plurality of integral channels arranged to define an oscillating heat pipe.

The vane may have a suction surface and a pressure surface, and wherein the vane comprises a plurality of conducting members extending from the channels towards the suction surface and/or the pressure surface.

The vane may comprise one or more features of the vane of the previous aspect.

According to an aspect there is provided a gas turbine engine comprising the vane according to one of the previous aspects.

The vane may be a fan engine section stator vane, for example a non-structural engine section stator vane.

The gas turbine engine may comprise a gearbox having an oil manifold. The vane may be positioned proximal to the oil manifold, such that heat can be transferred from the oil manifold to the vane.

A fluid may be provided in the channels and the properties of the fluid may be such that the fluid is a bi-phase in the channels during operation of the gas turbine engine (e.g. when heated by oil in the gearbox manifold).

According to an aspect there is provided a component comprising a body having an arrangement of internal channels. A plurality of conducting members extends from the channels towards one or more outer surfaces of the component.

According to an aspect there is provided a gas turbine engine comprising the component according to the previous aspect.

The component may be positioned in a gas path of the gas turbine engine.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a sectional side view of a gas turbine engine;

FIG. 2 is a sectional side view of a forward portion of a gas turbine engine;

FIG. 3 is a schematic of an oscillating heat pipe;

FIG. 4 is a perspective view of a vane;

FIGS. 5 and 6 are perspective views of alternative core members for the vane of FIG. 4; and

FIG. 7 is a sectional view of the vane of FIG. 4 cut in a plane that extends in a thickness direction and a chordwise direction of the vane.

### DETAILED DESCRIPTION

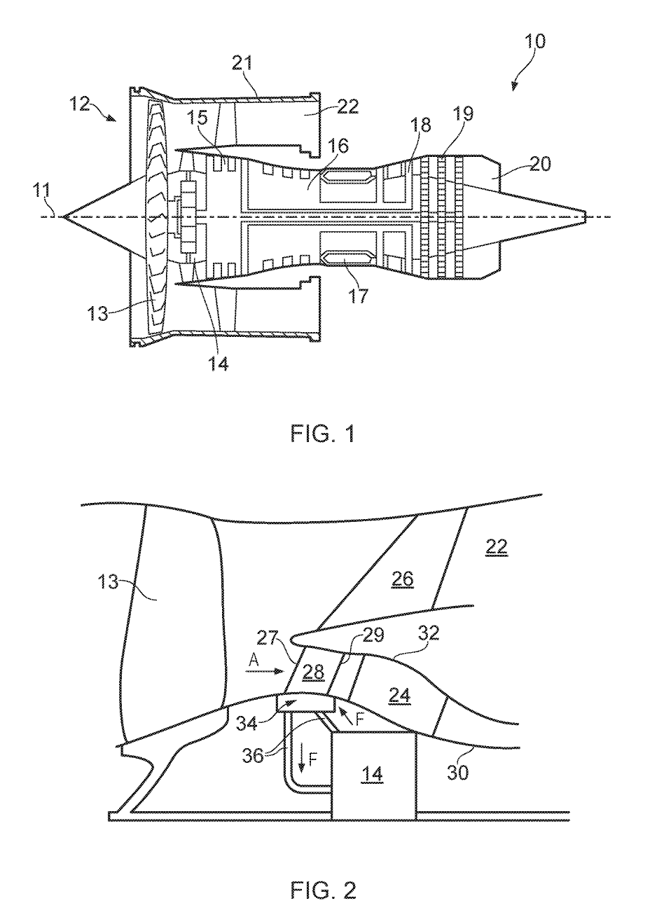

With reference to FIG. 1, a gas turbine engine is generally indicated at 10, having a principal and rotational axis 11. The engine 10 comprises, in axial flow series, an air intake 12, a propulsive fan 13, a gearbox 14, an intermediate pressure compressor 15, a high-pressure compressor 16, combustion equipment 17, a high-pressure turbine 18, a low-pressure turbine 19 and an exhaust nozzle 20. A fan casing 21 generally surrounds the fan blades and defines the intake 12.

The gas turbine engine 10 works in the conventional manner so that air entering the intake 12 is accelerated by the fan 13 to produce two air flows: a first air flow into the intermediate pressure compressor 15 and a second air flow which passes through a bypass duct 22 to provide propulsive thrust. The intermediate pressure compressor 15 compresses the air flow directed into it before delivering that air to the high pressure compressor 16 where further compression takes place.

The compressed air exhausted from the high-pressure compressor 16 is directed into the combustion equipment 17 where it is mixed with fuel and the mixture combusted. The resultant hot combustion products then expand through, and thereby drive the high 18 and low-pressure 19 turbines before being exhausted through the nozzle 20 to provide additional propulsive thrust. The high 18 and low 19 pressure turbines drive respectively the high pressure compressor 16 and intermediate pressure compressor 15, each by suitable interconnecting shaft. The low pressure shaft also drives the fan 13 via the gearbox 14. The gearbox 14 is a reduction gearbox in that it gears down the rate of rotation of the fan 13 by comparison with the intermediate pressure compressor 15 and low pressure turbine 19. The gearbox 14 is an epicyclic planetary gearbox having a static ring gear, rotating and orbiting planet gears supported by a planet carrier and a rotating sun gear.

Other gas turbine engines to which the present disclosure may be applied may have alternative configurations. By way of example the gearbox may be a star gearbox rather than an epicyclic planetary gearbox. Additionally or alternatively the gearbox may drive additional and/or alternative components (e.g. the intermediate pressure compressor and/or a booster compressor). The gearbox may even be omitted altogether. Additionally or alternatively such engines may have an alternative number of compressors and/or turbines and/or an alternative number of interconnecting shafts.

Referring to FIG. 2, air flow entering the bypass duct 22 is guided by fan outlet guide vanes 26, and air flow entering the core is guided by engine section stator (ESS) vanes 28. The ESS vanes and a strut 24 extend between an inner casing member 30 and an outer casing member 32. In the present example, the strut 24 is structural but the ESS vanes are non-structural. A plurality of ESS vanes are spaced circumferentially around the entrance to the core. The ESS vanes have a leading edge 27 and a trailing edge 29, and have an aerofoil profile. The aerofoil profile has a suction surface extending from the leading edge to the trailing edge and a pressure surface extending from the leading edge to the trailing edge.

The gearbox 14 is associated with a manifold 34 connected to the gearbox by pipes 36. Oil from the gearbox circulates to the manifold as indicated by arrows F. During operation of the gas turbine engine the oil of the gearbox will be elevated in temperature.

As discussed previously, the ESS vanes are non-structural. The ESS vanes are also thin so as to reduce noise. However, due to the lower speed of the fan and the thin geometry of the vanes ice formation on the vanes is potentially a bigger problem than in other engine designs.

In the present example, oscillating heat pipes (OHPs) are provided in the ESS vanes so as to reduce or eliminate ice build-up on the vanes. In exemplary embodiments, flow paths of the OHPs are integrally formed in the ESS vanes. OHPs may also be referred to as pulsating heat pipes (PHPs) or oscillating loop heat pipes (OLHP). Oil from the gearbox 14, in this example oil in the manifold 34, provides a heat source for the OHPs.

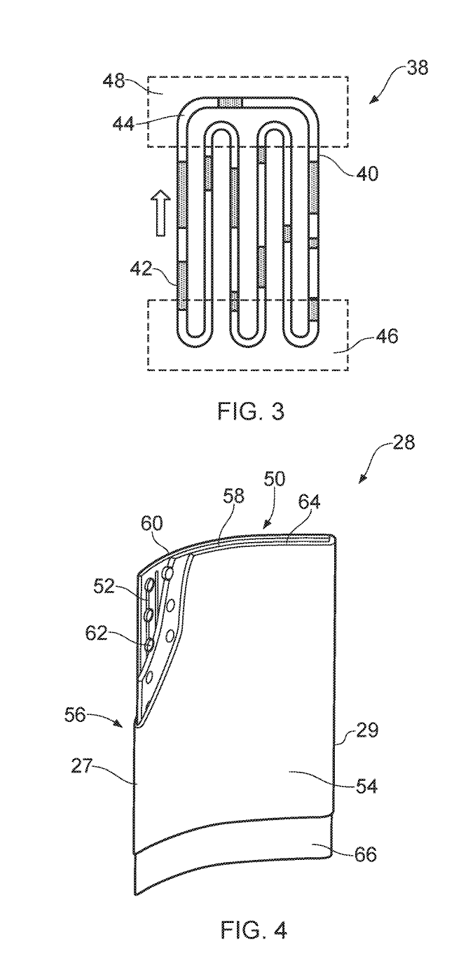

Referring to FIG. 3, an example of a closed loop OHP 38 is illustrated. The OHP includes a fluid flow path 40, which in exemplary embodiments may be of capillary dimension. The fluid flow path oscillates so as to define a series of U-turns. A bi-phase fluid, that is liquid slugs 42 and vapour plugs 44, flows along the path. In this example, the fluid is any one or any combination of glycol, water alcohol, and/or refrigerant. The flow path oscillates between an evaporator 46 and a condenser 48. The evaporator is a heat source and the condenser is a region cooler than the heat source. A differential pressure between the evaporator and condenser, due to a temperature difference, drives the fluid along the flow path oscillating between the evaporator and the condenser.

Referring to FIGS. 4 to 6, an ESS vane 28 of the present example will be described in more detail. The vane has a pressure surface 54 and a suction surface 56. The vane includes a core 50 that defines an aerofoil. The core 50 is formed from two parts 58, 60; one of the two parts defines the suction surface of the aerofoil and the other part defines the pressure surface of the aerofoil, and each of the two parts extends the full chordwise extent of the aerofoil. In the present example, the core 50 is plastic and is formed by plastic injection moulding. However, in alternative embodiments other forming methods may be used.

Grooves 52 are provided in one of the two parts of the core 50, in this case the part 60 that defines the suction side of the aerofoil. However, in alternative embodiments the grooves may be provided in the other part 58, or in both parts 58 and 60. The grooves together define channels through which a heat transfer fluid can flow. The grooves 52 are provided towards the leading edge 27 of the vane 28. In the present example a region proximal to the trailing edge 29 is free from grooves. Indeed in the present example at least a rearward half of the vane is free from grooves.

A fluid is provided in the channels. The fluid is one or any combination of glycol, water alcohol, and/or refrigerant.

A plurality of conduction members 62 is provided. The conduction members in the present example extend from the grooves 52 to the pressure surface 54 and the suction surface 56 of the vane. Referring to FIG. 7, the conduction members, have an elongate body and may be referred to as pins. In the present example, the conduction members are waisted. That is, the body of the conduction members is narrower in a region of the groove 52 than in a region proximal to the pressure surface 54 and suction surface 56 of the vane. The conduction members 62 include fins that project outwardly from a body of the conduction member. The fins project outwardly into the grooves 52 of the core 50. In the present example, the conduction members are metallic, for example they are made from aluminium or an aluminium alloy, but could be any heat conducting material.

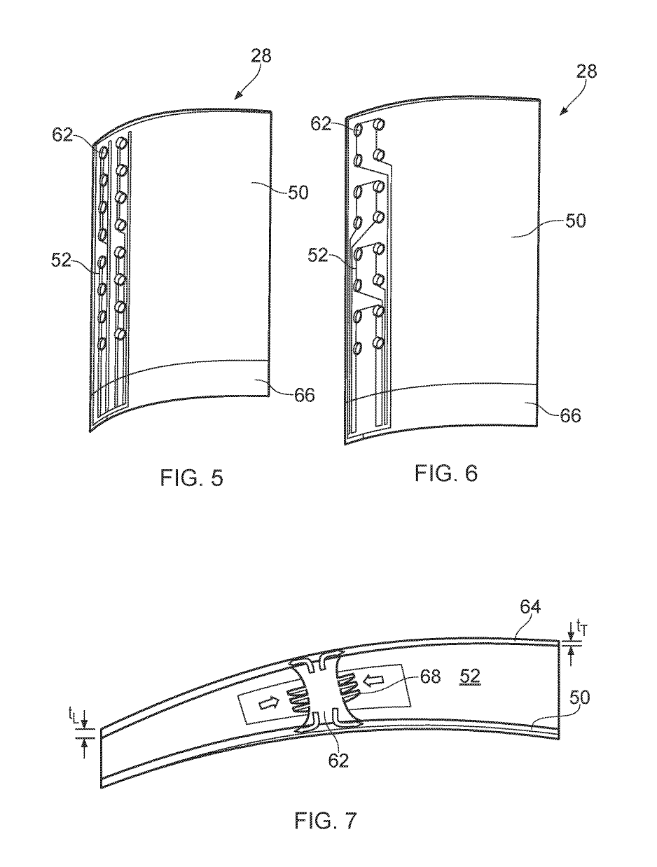

Referring again to FIGS. 5 and 6, the grooves 52 and the conduction members 62 may have any suitable arrangement. For example, as shown in FIG. 5, the grooves may extend substantially entirely in a spanwise direction, and the conduction members are arranged along the spanwise length of the grooves. In the example shown in FIG. 6, the grooves are formed to have portions in a chordwise direction as well as in a spanwise direction. The conduction members are arranged along the length of the grooves, and are arranged adjacent each other in a spanwise direction or a chordwise direction, depending on the direction of the groove in the respective region of the conduction member.

Referring to FIGS. 4 and 7, the vane 28 has a metallic coating 64. In this example the metallic coating is a nanocrystalline metallic coating. The coating is provided to cover the entire gas washed surface of the vane 28, i.e. the coating extends to cover the suction surface, pressure surface, leading edge and trailing edge of the blade. In the present example, the thickness t_{L} of the coating at the leading edge and in a region proximal to the leading edge is thicker than a thickness t_{T} of the coating at the trailing edge and in a region proximal to the trailing edge. In this way, heat conduction at the leading edge is increased. In alternative embodiments, an alternative thickness distribution of coating may be applied, for example, a thicker coating can be applied in regions where increased heat conduction is desired.

Referring to FIGS. 4 to 6, the vane 28 includes a portion 66 at one spanwise end of the vane that is metallic. In this example, the portion 66 can be considered to be the base of the vane 28. When the vane 28 is positioned in the gas turbine engine 10, the portion 66 is proximal to a heat source, which in this example is the oil in the oil manifold (i.e. in this example the portion 66 is positioned proximal to the oil manifold).

The vane 28 may be connected to an inner and/or outer casing member of the gas turbine engine in a number of ways. Including rigidly connecting the vane to an outer casing member and positioning an opposite end of the vane in a recess of an inner casing member. The recess may be filled with heat conductive material, for example metal. The recess may protrude into the oil manifold and may have a plurality of fins projecting into the oil manifold to increase heat flow from the oil to the vane 28.

In use, the oil in the manifold will be at an elevated temperature, as such, the oil is a heat source. The portion 66 ensures that heat is conducted from the oil to the fluid in the channels defined by the grooves 52. The heat causes a portion of the fluid in the channels to vapourise, such that vapour plugs and liquid slugs move along the channels. When the fluid contacts the conduction members 62, the vapour condenses onto the conduction members and hot fluid flows past the conduction members, in this way heat is transferred to the conduction members. The conduction members conduct heat to the metallic coating 64. This heat conduction warms up the metallic coating so as to reduce the risk of ice forming, or to melt ice that has formed, at the leading edge of the vane 28. In the present example, the leading edge of the vane is the region most susceptible of ice formation.

The channels and heat conducting members may perform an anti-icing function. That is, the channels and heat conducting members may prevent ice forming on the vane. Alternatively, the channels and heat conducting members may perform a de-icing function. That is, flow of fluid through the channels may be selectively turned on and off, e.g. using a valve, when fluid flow is on, the fluid can melt any ice formed on the vane.

The conduction members can improve heat transfer to the gas washed surface of the vane compared to only using oscillating heat pipes. Furthermore, the nanocrystalline metallic coating has good heat conduction properties, further improving the amount of heat conduction to the gas washed surface of the vane.

The channels and conduction members can be arranged to achieve a desired heat distribution, with the path being defined by the channels and/or the position of the heat conducting members being selected so as to increase heat conduction in a desired region of the vane.

Forming the core from plastic can reduce the weight of the vane. Forming the channels in the core can help to minimise the thickness of the vanes. Thickness of the vanes can also be reduced due to the arrangement of the grooves, conduction members and/or nanocrystalline coating, because improved transfer of heat to the gas washed surface of the vane can reduce the number of channels required, which may in turn reduce the thickness requirements of the vane.

The core has been described as being made from a plastics material, but in alternative embodiments the core may be made from any other heat insulating material. Alternatively, the core may be made from a non-heat-insulating material, and insulation can be added to the vane as required. In exemplary embodiments, the core may be made from a reinforced plastic material or may be made from ceramic.

The core has been described as having two parts, but in alternative embodiments the core may be made from a single part and the channels may be integrally formed during the manufacturing process, for example during a moulding process. In further alternative embodiments the core may be made from three or more parts.

The arrangement of internal channels and conduction members has been described with respect to an ESS vane, but it will be appreciated by the person skilled in the art that this arrangement can be applied to any vane of a gas turbine engine. Furthermore this arrangement may be applied to any other structure requiring de-icing or anti-icing, where there is an accessible heat source, for example other components of a gas turbine engine, or components in other industries, for example a ship's hull.

In the described example, oscillating heat pipes are used because efficient and effective operation is not dependent upon gravity assistance. However, in alternative components, or in vanes without the need for gravity assistance, alternative heat pipe arrangements may be used. For example, the heat pipes may be straight rather than oscillating, and/or the pipes may be of a simple capillary dimension, and/or the pipe may include a mesh to allow fluid flow via capillary action and under gravity.

In the described examples, the channels and conducting members have been provided proximal to the leading edge of the vane, but it will be appreciated that the channels and conducting members can be positioned where heating is required so as to achieve a desired heat distribution on a component.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A vane for a gas turbine engine, the vane having a pressure surface and a suction surface, and the vane comprising:
an arrangement of internal channels defining oscillating heat pipes; and
a plurality of conducting members extending from the channels towards the suction surface and/or the pressure surface.

2. The vane according to claim 1, wherein the vane comprises a core that defines an aerofoil profile, and wherein the channels are formed in the core.

3. The vane according to claim 2, wherein the core is formed of two members, one defining the suction surface and the other defining the pressure surface, and wherein the channels are defined by grooves in one or both of the two members.

4. The vane according to claim 2, wherein the core comprises a plastic material.

5. The vane according to claim 1, wherein each conducting member extends from the channel towards the suction surface and towards the pressure surface.

6. The vane according to claim 1, wherein the conducting members are elongate members having a principal axis in a direction extending between the suction surface and the pressure surface.

7. The vane according to claim 1, wherein the conducting members comprise fins that project into the channels.

8. The vane according to claim 1, wherein the conducting members are waisted so as to taper outwardly away from the channel.

9. The vane according to claim 1, wherein the conducting members are metallic members.

10. The vane according to claim 1, wherein one spanwise end of the vane is made from a metallic material.

11. The vane according to claim 1, wherein the pressure surface and/or the suctions surface and/or a transition region there between is coated in a heat conducting material.

12. The vane according to claim 11, wherein metallic coating is a nanocrystalline metallic coating.

13. The vane according to claim 11, wherein the metallic coating is thicker in a region proximal to a leading edge of the vane than in a region proximal to a trailing edge of the vane.

14. The vane according to claim 1, wherein the channels and the conducting members are arranged towards the leading edge of the vane.

15. A gas turbine engine comprising the vane according to claim 1.

16. The gas turbine engine according to claim 15, wherein the vane is a fan engine section stator vane.

17. The gas turbine engine according to claim 15, comprising a gearbox having an oil manifold, and wherein the vane is positioned proximal to the oil manifold, such that heat can be transferred from the oil manifold to the vane so that oil in the oil manifold is a heat source to the vane.

18. A vane comprising a core body defining an aerofoil profile, the core body comprising a plurality of integral channels arranged to define an oscillating heat pipe.

19. The vane according to claim 18, wherein the vane has a suction surface and a pressure surface, and wherein the vane comprises a plurality of conducting members extending from the channels towards the suction surface and/or the pressure surface.
